(19) United States
(12) Patent Application Publication
(10) Pub. No.: US 2023/0312922 A1
(43) Pub. Date: Oct. 5, 2023

(54) POLYAMIDE MOLDING MATERIAL WITH HIGH FRACTURE STRENGTH AND MOLDED PARTS PRODUCED THEREFROM

(71) Applicant: EMS-CHEMIE AG, Domat/Ems (CH)

(72) Inventors: Etienne AEPLI, Domat/Ems (CH); Botho HOFFMANN, Domat/Ems (CH)

(73) Assignee: EMS-CHEMIE AG, Domat/Ems (CH)

(21) Appl. No.: 18/191,076

(22) Filed: Mar. 28, 2023

(30) Foreign Application Priority Data
Mar. 29, 2022 (EP) 22 165 144.1

(51) Int. Cl. C08L 77/06; C08L 77/02; C08K 13/02

(52) U.S. Cl. CPC C08L 77/06; C08L 77/02; C08K 13/02; C08L 2205/025; C08K 5/0041

(57) ABSTRACT

The present invention relates to a polyamide molding material with high fracture energy and molded parts produced therefrom which are particularly suitable for visible parts for automotive parts or for electronic devices. The polyamide molding material has, in addition to excellent fracture energy, a likewise excellent piano lacquer finish and a high rubbing resistance.

### CROSS-REFERENCE TO RELATED APPLICATIONS

This patent application claims the benefit of European Patent Application No. 22 165 144.1, filed on Mar. 29, 2022, the disclosure of which is incorporated herein by reference in its entirety for all purposes.

### BACKGROUND OF THE INVENTION

The present invention relates to a polyamide molding material with high fracture energy and molded parts produced therefrom which are particularly suitable for visible parts for automotive parts or for electronic devices. The polyamide molding material has, in addition to excellent fracture energy, a likewise excellent piano lacquer finish and a high rubbing resistance.

### PRIOR ART

EP 1 930 373 A2 relates to transparent molded parts, which are formed from select polyamide molding materials, whose physical properties, in particular their transparency and their dynamic resistance, are superior to those of polycarbonate. The transparent polyamides underlying these molding materials are formed from at least two aliphatic diamines and at least two aromatic dicarboxylic acids and, if necessary, lactams. Mixtures made of these transparent polyamides with other polyamides are mentioned, however, not used in the examples.

EP 3 336 131 A1 relates to transparent polyamide molding materials based on transparent, cycloaliphatic polyamides, as they may be used, for example, in housing components, also in the household sector, sporting goods or toy area, and which have a high elongation at break. The molding materials may also contain other polymers, in particular polyamides.

EP 3 450 481 A1 relates to polyamide molding materials with high gloss and high notch impact strength. The molding materials are thereby based on the amorphous or microcrystalline copolyamides 6I/6T/MACMI/MACMT/PACMI/PACMT/Y or PA 6I/6T/MACMI/MACMT/Y, where Y stands for lactams or ω-amino acids which are impact modified with functionalized copolymers made from ethylene propylene, and 1-butene. Aliphatic polyamides as blending components are not mentioned.

EP 3 502 164 A1 relates to polyamide molding materials, which are based on a mixture of specific amorphous polyamides and specific semi-crystalline polyamides and which are characterized by a very good stress cracking resistance and simultaneously by very good optical properties, in particular a high light transmission and a low haze. The semi-crystalline polyamides are long-chain aliphatic polyamides.

EP 3 502 191 A1 relates to polyamide molding materials, which are based on a mixture of specific amorphous or microcystalline polyamides and the semi-crystalline polyamides PA 616, PA 516, PA 1016, and which are characterized by a very good stress cracking resistance and simultaneously by very good optical properties.

EP 2 055 743 A1 describes the use of a molding material made from a polyamide mixture, containing an aliphatic homo- or copolyamide and a transparent homo- or copolyamide and, if necessary, fillers or reinforcing materials and additives. The proposed use is the manufacture of a molded part for drinking water, in particular a container or a conduit, in the intended use of which, at least areas of the processed molding material are exposed substantially directly to the drinking water. Only PA12 is used as an aliphatic polyamide in the examples.

Fully aliphatic polyamides, like polyamide 66 do indeed have a high mechanical resistance, however, they are crystalline. The crystallites refract or scatter the light; therefore, the molding material is silky due to the Tyndall effect, or has a streaky appearance. Therefore, crystalline polyamide molding materials have a transparency that is too low and a haze that is too high in order to be able to produce parts from them that are visually appealing and high quality, and that are visible in the installed state.

The prior art has thus not previously solved the problem of providing polyamide molding materials which only forfeit their dimensional stability (determinable based on the fracture energy) after high energy absorption, and thus have an increased level of safety, in particular with respect to shock-like mechanical loads yet simultaneously have an excellent appearance. Molded parts made from molding materials produced in this way are used in particular as visible parts in automobile parts or electronic devices. At the same time, the polyamide molding materials are to preferably have a so-called piano lacquer finish, thus convey the impression of a darkest black paired with a high gloss. It is further preferred that the polyimide molding materials additionally and simultaneously have a high stability against abrasive influences, thus are rub resistant.

This problem is solved with the molding materials and the molded parts according to the invention disclosed herein, and the advantageous refinements thereof.

### Definitions of Terms Notations and Abbreviations for Polyamides and the Monomers Thereof

In the sense of the present invention, the term “polyamide” (abbreviation PA) is understood as an umbrella term; it comprises homopolyamides and copolyamides. The selected designations and abbreviations for polyamides and their monomers correspond to those defined in DIN EN ISO standard 16396-1:2015. The abbreviations used therein are used hereafter synonymously for the IUPAC names of the monomers, in particular, the following abbreviations for monomers are found: MACM for bis(4-amino-3-methylcyclohexyl)methane (also designated as 3,3′-dimethyl-4,4′-diaminodicyclohexylmethane, CAS no. 6864-37-5), PACM for bis(4-aminocyclohexyl)methane (also designated as 4,4′-diaminodicyclohexylmethane, CAS no. 1761-71-3), TMDC for bis-(4-amino-3,5-dimethylcyclohexyl)methane (also designated as 3,3′,5,5′-tetramethyl-4,4′-diaminodicyclohexylmethane, CAS no. 65962-45-0), T for terephthalic acid (CAS no. 100-21-0), I for isophthalic acid (CAS no. 121-95-5), BAC for 1,4-bis(aminomethyl)cyclohexane (CAS no. 2549-93-1).

### QUANTITIES

The polyamide molding materials according to the present invention contain the components a) to d) or preferably consist exclusively of the components a) to d). The provision thereby applies that the components a) to d) add in sum to 100 wt. %. The fixed ranges of the indications of quantity for the individual components a) to d) are to be understood such than an arbitrary quantity for each of the individual components may be selected within the specified ranges, provided that the strict provision is satisfied that the sum of the components a) to d) produces 100 wt. %.

### Amorphous or Microcrystalline Polyamides

Amorphous or microcrystalline polyamides, in differential scanning calorimetry (DSC) according to DIN EN ISO 11357-3 (2018), at a heating rate of 20 K/min, preferably show a heat of fusion of no more than 25 J/g, particularly preferably of no more than 22 J/g, and most particularly preferably 0 to 20 J/g.

Microcrystalline polyamides also have a melting point, in addition to a glass transition temperature. However, they have a morphology in which the crystallites have such a small dimension that a plate manufactured therefrom having a thickness of 2 mm is still transparent, i.e. its light transmission amounts to at least 88% or at least 90% and its haze is at most 3%, measured in accordance with ASTM D 1003-21 (2021).

Amorphous polyamides have no heat of fusion or only a very low, scarcely detectable heat of fusion, compared to the microcrystalline polyamides. Amorphous polyamides, in differential scanning calorimetry (DSC) according to DIN EN ISO 11357-3 (2018), at a heating rate of 20 K/min, preferably show a heat of fusion of no more than 5 J/g, particularly preferably of no more than 3 J/g, and most particularly preferably 0 to 1 J/g. Amorphous polyamides have no melting point due to their amorphicity.

In the meaning of the invention, semi-crystalline polyamides are those polyamides which, in differential scanning calorimetry (DSC) according to DIN EN ISO 11357-3 (2018), at a heating rate of 20 K/min, preferably show a heat of fusion of more than 25 J/g, particularly preferably of more than 30 J/g, and most particularly preferably at least 35 J/g. A plate manufactured from semi-crystalline polyamides having a thickness of 2 mm is not transparent, i.e., its light transmission lies below 88% and/or its haze above 5%, respectively measured in accordance with ASTM D 1003-21 (2021).

### Transparent Polyamides

In the meaning of the present invention, a transparent polyamide is defined to have a light transmission, measured in accordance with ASTM D 1003-21 (2021) on plates having a thickness of 2 mm, of at least 88% or at least 90% and a haze of at most than 5%, preferably at most 3%. If transparent polyamides are adressed in the following, always amorphous or microcrystalline polyamides are meant, which satisfy the above definitions with respect to transparency and heat of fusion.

### SUMMARY OF THE INVENTION

The present invention thus relates to a polyamide molding material comprising the following components or preferably consisting of the following components:
a) 93.0 to 99.9 wt. % of a mixture M consisting of
15.0 to 50.0 wt. % of at least one polyamide X and
50.0 to 85.0 wt. % of at least one polyamide Y, selected from the group consisting of PA6, PA66, PA6/66, PA610, PA612, PA 614, PA 616, PA 6/12, and mixtures thereof;
b) 0.05 to 5.0 wt. % additives;
c) 0.01 to 2.0 wt. % of at least one coloring agent;
d) possibly, ingredients other than components a) to c);
wherein the at least one polyamide X is selected from the group consisting of polyamides, which comprise at least the amidically-bonded polyamide units AC, BC and E, or AC, BC, AD and BD, or AC and E, derived from the monomer units A, B, C, D, and/or E, wherein the monomer units A, B, C, D, and E have the following definition:
A: at least one cycloaliphatic diamine;
B: at least one acyclic aliphatic diamine;
C: at least one aromatic dicarboxylic acid;
D: at least one aliphatic dicarboxylic acid;
E: at least one α,ω-amino carboxylic acid or at least one lactam;
wherein the sum of the components X and Y yields 100 wt. % of the mixture M and the sum of the components a), b), c), and d) yields 100 wt. %.

It has surprisingly been found that the polyamide molding material according to the invention has an extremely high energy absorption and thus fails later with respect to mechanical loads, e.g., due to the effect of tensile stress or shock-like mechanical loads, than polyamide compositions known from the prior art. The polyimide molding materials according to the invention are thus superior with respect to their safety to compositions from the prior art. At the same time, the compositions have an excellent external appearance and may thus be used for high quality applications, e.g. components visible in the installed state for example, in the vehicle interior.

### POLYAMIDE MIXTURE

The polyimide mixture M, contained in the polyamide molding material according to the invention, contains 15.0 to 50.0 wt. % of a polyimide X and 50.0 to 85.0 wt. % of a polyamide Y. The proportions by weight of the components X and Y thereby add to 100 wt. % of the mixture M. It is preferred that the amount of polyamide X in the mixture is smaller than the amount of polyamide Y, i.e., the amount of polyimide X is less than 50 wt. % relative to the mixture. In the same way, it is preferred that the amount of polyamide Y is greater than 50 wt. %.

The polyimide mixture M preferably consists of 15.0 to 45.0 wt. %, preferably 20.0 to 42.0 wt. %, particularly preferably 25.0 to 38.0 wt. % of the at least one polyamide X and a complementary proportion of the polyimide Y, i.e., 55.0 to 85.0 wt. %, preferably 58.0 to 80.0 wt. %, particularly preferably 62.0 to 75.0 wt. % of the at least one polyamide Y.

### Polyamide X

Polyamide X is a transparent polyamide which preferably contains at least 50 mol % monomers with exclusively aliphatic structural units, relative to the total amount of monomers in polyamide X. Polyamide X is preferably amorphous or microcrystalline.

The at least 50 mol % of monomers with exclusively aliphatic structural units may be aliphatic diamines, aliphatic dicarboxylic acids, aliphatic lactams or aliphatic aminocarboxylic acids. Polyamide X is thus composed from at least 50 mol % monomers with exclusively aliphatic structural units and no more than 50 mol % monomers which contain aromatic structural units.

It is further preferred that polyamides X are transparent and have a transparency of at least 88% or at least 90% and a haze of at most 5% preferably at most 3% (respectively determined using subsequently explained measurement methods).

According to one preferred embodiment of the present invention, polyamide X is amorphous.

According to another preferred embodiment of the present invention, polyamides X contain at least one monomer with aromatic structural units.

The polyamides X preferably have a relative viscosity, measured in accordance with ISO 307:2007 in a solution of 0.5 g polymer in 100 ml m-cresol at 20° C., in the range from 1.35 to 2.40, particularly preferably from 1.40 to 1.90, and more particularly preferably from 1.45 to 1.80.

For example, relative viscosities for polyamides, which have at least polyamide units AC, BC, and E, lie preferably in the range from 1.50 to 1.75, in particular from 1.59-1.64.

For example, relative viscosities for polyamides, which have at least polyamide units AC, BC, AD, and BD, lie preferably in the range from 1.60 to 1.85, in particular from 1.70-1.75.

For example, relative viscosities for polyamides, which have at least polyamide units AC and E, lie preferably in the range from 1.40 to 1.65, in particular from 1.51-1.57.

For polyamide X, the monomer units A to E are preferably selected independently from one another from the group consisting of
A: (cycloaliphatic diamines): bis-(4-amino-3-methyl-cyclohexyl)-methane (MACM), bis(4-amino-cyclohexyl)methane (PACM), bis-(4-amino-3,5-dimethyl-cyclohexyl)-methane (TMDC) and mixtures thereof;
B: (acyclic aliphatic diamines): 1,6-hexanediamine, 2-methyl-1,8-octanediamine, 1,9-nonanediamine, 1,10-decanediamine, 1,12-dodecane-diamine, preferably selected from 1,6-hexanediamine and 1,10-decanediamine;
C: (aromatic dicarboxylic acids) are selected from the group consisting of terephthalic acid, isophthalic acid and mixtures thereof, preferably a mixture of terephthalic acid and isophthalic acid;
D: (aliphatic dicarboxylic acids): adipic acid, azelaic acid, 1,10-decanedioic acid, 1,12-dodecanedioic acid, 1,14-tetradecanedioic acid, 1,16-hexadecanediodc acid, cyclohexane-1,3-dicarboxylic acid, cyclohexane-1,4-dicarboxylic acid and mixtures thereof;
E: (α,ω-aminocarboxylic acids or lactams) are selected from the group consisting of α,ω-aminohexanoic acid, α,ω-aminoundecanoic acid, α,ω-aminododecanoic acid, caprolactam, laurolactam and mixtures thereof.

According to another preferred embodiment, the polyamide unit AC of polyamide X comprises at least two different, preferably exactly two different cycloaliphatic diamines, in particular bis-(4-amino-3-methyl-cyclohexyl)-methane (MACM) and bis(4-amino-cyclohexyl)methane (PACM).

It is additionally preferred that polyamide X imperatively contains polyamide units AC and BC.

It is likewise preferred that polyamide X does not contain any monomer units D.

It is particularly preferred that polyamide X contains polyamide units AC, BC, and E, polyamide X consists most particularly preferably of polyamide units AC, BC, and E.

It is further advantageous that polyamide X contains more than 30 mol %, preferably more than 40 mol %, more particularly more than 42 mol %, particularly preferably in the range from 30 to 50 mol % or 40 to 50 mol % or 42 to 50 mol % of monomers with aromatic structural units, relative to the total amount of monomers.

In particular, polyamide X is selected from the group consisting of PA 6I/6T/MACMI/MACMT/PACMI/PACMT/12, PA 6I/6T/MACMI/MACMT/MACM12/612, PA MACMI/12, PA MACMT/12, PA 10I/MACMI/MACM10/1010, PA 10T/MACMT/MACM10/1010, PA 10I/10T/MACMI/MAMT/MACM10/1010 PA MACMI/MACMT, PA MACMI/MACMT/12, PA MACMI/MACMT/MACM12, PA 6I/6T/MACMI/MACMT, PA 6I/6T/MACMI/MACMT/12, PA 6I/612/MACMI/MACM12, PA 6T/612/MACMT/MACM12, PA 6I/6T/612/MACMI/MACMT/MACM12, PA 6I/6T/MACMI/MACMT/-PACMI/PACMT/MACM12/PACM12 and mixtures thereof.

### Polyamide Y

Polyamide Y is at least one acyclic aliphatic polyamide. The polyamides Y are selected from the group consisting of PA6, PA66, PA6/66, PA610, PA612, PA 614, PA 616, PA 6/12 and mixtures thereof.

The polyamides Y preferably have a relative viscosity, measured in accordance with ISO 307:2007 in a solution of 1.0 g polymer in 100 ml sulphuric acid at 20° C., in the range from 2.10 to 3.60, particularly preferably from 2.30 to 3.50, and more particularly preferably from 2.40 to 2.80.

Surprisingly, the observed improvement of the fracture energy is obtained first by the selection and combination of specific polyamides X and Y, while simultaneously obtaining the visual appearance that enables a suitability of the molding materials for high quality components.

### Additives (b)

The molding material according to the invention contains as component b) at least one additive which is preferably selected from the group consisting of organic and inorganic stabilizers, in particular antioxidants, antiozonants, heat stabilizers, light stabilizers, UV stabilizers, UV absorbers or UV blockers, lubricants, demolding agents, and mixtures and combinations thereof.

The amount of the at least one additive is 0.05 to 5.0 wt. %, preferably 0.10 to 3.0 wt. %, further preferably 0.20 to 2.5 wt. % and particularly preferably 0.25 to 2.3 wt. %, respectively relative to the sum of components a) to d).

In the case that a stabilizer is used as the at least one additive, this may be selected according to one preferred embodiment from the following group:
compounds of monovalent or divalent copper, in particular salts of the monovalent or divalent copper with organic or inorganic acids or monovalent or divalent phenols, oxides of the monovalent or divalent copper, or complex compounds of copper salts with ammonia, amines, amides, lactams, cyanides, or phosphines, preferably Cu(I) or Cu(II) salts of hydrohalic acids, hydrocyanic acids, or the copper salts of aliphatic carboxylic acids, wherein the monovalent copper compounds are particularly preferably CuCl, CuBr, CuI, CuCN, and Cu2O and the divalent copper compounds are particularly preferably CuCl2, CuSO4, CuO, copper(II)acetate or copper (II)stearate, or mixtures of these compounds, wherein these copper compounds are used as such or preferably in the form of concentrates. A concentrate is understood to be a polymer, of preferably identical or substantially identical chemical nature as the polyamides X or Y, which concentrate contains the copper salt or the copper compound in high concentration (masterbatch). It is more particularly preferred that the copper compounds are used in combination with additional metal halides, including alkali halides like Nal, Kl, NaBr, KBr, wherein the molar ratio of metal halide to copper is 0.5 to 20, preferably 1 to 10, and particularly preferably 2 to 7;
stabilizers based on secondary aromatic amines;
stabilizers based on sterically hindered phenols;
phosphites and phosphonites;
stabilizers selected from the group consisting of N,N′-oxamide,
hydroxyphenyltriazine, hydroxyphenylbenzotriazole, dibenzoylmethane, aminohydroxybenzoyl benzoic acid ester, hydroxybenzophenon, hindered amine light stabilizers (HALS), and
mixtures of the previously mentioned stabilizers.

Particularly preferred examples according to the invention for usable stabilizers based on secondary aromatic amines are adducts of phenylenediamine with acetone (Naugard A), adducts of phenylenediamine with linoleic acid, Naugard 445, N,N′-dinaphthyl-p-phenylenediamine, N,N′-dinaphthyl-p-phenylenediamine, or mixtures of two or more thereof.

Particularly preferred examples according to the invention for usable stabilizers based on sterically hindered phenols are N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethyl-bis-(3-(3,5-di.tert-butyl-4-hydroxyphenyl)-propionate, 4-4′-butylidene-bis-(3-methyl-6-tert.-butylphenol), triethylene glycol-3-(3-tert-butyl-4-hydroxy-5-methylphenyl)-propionate, or mixtures of two or more of these stabilizers.

Preferred phosphites and phosphonites are triphenyl phosphite, diphenyl alkyl phosphite, phenyl dialkyl phosphite, tris(nonylphenyl) phosphite, trilaurylphosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyl-oxy-pentaerythritol diphosphite, bis(2,4-di-tert-butyl-6-methylphenyl)pentaerythritol diphosphite, bis(2,4,6-tris-(tert-butylphenyl))pentaerythrital diphosphite, tristearyl sorbitol triphosphite, tetrakis(2,4-di-tert-butylphenyl)-4,4′-biphenylene diphosphonite, 6-isooctyloxy-2,4,8,10-tetra-tert-butyl-12H-dibenz-[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methyl phosphite. and bis(2,4-di-tert-butyl-6-methylphenyl)ethyl phosphite. More particularly preferred are tris[2-tert-butyl-4-thio(2′-methyl-4′-hydroxy-5′-tert-butyl)-phenyl-5-methyl]phenyl-phosphite and tris(2,4-di-tert-butylphenyl) phosphite (Hostanox® PAR24: commercial products from Clariant, Basel).

One preferred embodiment of the heat stabilizer comprises the combination of Irgatec NC 66 (available from BASF) and a copper stabilizer based on Cul and Kl. A heat stabilizer based exclusively on Cul and Kl is particularly preferred.

According to another preferred embodiment, the heat stabilizers of component (b) are selected from the group of phenol-based heat stabilizers, phosphite-based heat stabilizers, amine-based heat stabilizers, or mixtures or combinations thereof, wherein in particular component C is preferably selected from the following group: triethyleneglycol bis(3-tert-butyl-4-hydroxy-5-methylphenyl)propionate, pentaerythritol-tetrakis(3-(3,5-di-tert-butyl-4-hydroxyphenyl)propionate), N,N′-hexamethylene-bis[3-(3,5-di-t-butyl-4-hydroxyphenyl)propionamide], tris-(2,4-di-tert-butylphenyl)phosphite, tris-(2,4-di-tert-butylphenyl)phosphite, or mixtures thereof.

Preferred organic stabilizers are phenol and/or phosphite compounds, like Irganox 245, Irganox 1010, Irganox 1098, Hostanox PAR 24, or Irgafos 168. Particularly preferred as component (D) is a mixture of 10 parts by weight of a mixture of Irganox 1010 (CAS 6683-19-8, phenolic antioxidant) and Anox 20 (CAS 6683-19-8, phenolic antioxidant) in a ratio of 7:3 and 2 parts by weight of Hostanox PAR24 (CAS: 31570-04-4, tris(2,4-ditert-butylphenyl)phosphite).

Preferred UV stabilizers are, for example, selected from the group consisting of N-(2-ethoxyphenyl)-N′-(2-ethylphenyl)oxamide (Tinuvin 312), 2-(4,6-diphenyl-1,3,5-triazine-2-yl)-5-hexyloxy phenol (Tinuvin 1577), 2-(4,6-diaryl-1,3,5-triazine-2-yl)-5-(alkoxy substituent)-phenol (Tinuvin 1600), 2-tert-butyl-6-(5-chlorobenzotriazole-2-yl)-4-methylphenol (Tinuvin 326), 2-(benzo-triazole-2-yl)-4,6-bis(2-phenylpropane-2-yl)phenol (Tinuvin 234), bis(2,2,6,6,-tetramethyl-4-piperidyl)sebacate (Tinuvin 770 DF), 2-(2-hydroxyphenyl)-benzotriazole derivative (Tinuvin Carboprotect), 2-(benzotriazole-2-yl)-4,6-bis(2-methylbutan-2-yl)phenol (Tinuvin 328), 2-(benzotriazole-2-yl)-6-[[3-(benzotriazole-2-yl)-2-hydroxy-5-(2,4,4-trimethylpentane-2-yl)phenyl]methyl]-4-(2,4,4-trimethylpentane-2-yl)phenol (Tinuvin 360) poly[[6-[(1,1,3,3-tetra-methylbutyl)amino]-1,3,5-triazine-2,4-diol][(2,2,6,6-tetramethyl-4-piperidinyl)-imino]-1,6-hexandiyl[(2,2,6,6-tetramethyl-4-piperidinyl)-imino]]) (Chimasorb 944 FD), 1-(4-methoxyphenyl)-3-(4-tert-butylphenyl)propane-1,3-dione (Parsol 1789), and mixtures thereof.

One preferred embodiment of the processing aid are aluminum salts, alkali salts, alkaline earth metal salts, esters or amides of fatty acids with 10 to 44 C atoms and preferably with 14 to 44 C atoms, wherein the metal ions Na, Mg, Ca, and Al are preferred, and Ca or Mg are particularly preferred. Particularly preferred metal salts are magnesium stearate, calcium stearate, and calcium montanate, and also aluminum stearate. The fatty acids may be mono or divalent. Listed as examples are: pelargonic acid, palmitic acid, lauric acid, margaric acid, dodecanedioic acid, behenic acid and particularly preferably stearic acid, capric acid, and also montanic acid (mixtures of fatty acids with 30 to 40 C atoms). According to another preferred embodiment, the processing aids, calcium stearate, glycerine monostearate, Abril 1033 or ACRAWAX C, are suitable.

### Coloring Agent (c)

Component c) is a coloring agent or mixture of coloring agents, which are suitable for coloring the polyamide molding material black. The black coloration and the visual appearance are carried out based on a visual assessment. Coloring agents may be organic or inorganic dyes or pigments. Dyes are coloring agents which normally do not scatter light but instead they absorb light at a certain visible wavelength. Dyes are often soluble at a certain concentration in the polymer matrix. Pigments are organic or inorganic dyes which are generally present in the polymer matrix as discrete, insoluble particles. The designation of a certain dye as a pigment or dye depends on the polymer matrix, the concentration of dye, and the crystallinity, temperature, and other factors. With respect to the present invention, preferred coloring agents are soluble in the polyamide molding material in the concentrations which are necessary to color the molded parts, wherein these may also be used in combination with carbon black.

According to the invention, coloring agents are used in amounts and in combinations which are sufficient to color the molding materials black and largely opaque. The specific amount of a used coloring agent depends, among other things, on its solubility and its extinction coefficients in the thermoplastic matrix, and whether it is used in combination with one or more additional coloring agents.

The proportion of component c) lies preferably in the range of 0.05 to 2.0 wt. % relative to the sum of components a) to d). According to one preferred embodiment of the present invention, the proportion of component c) lies in the range from 0.08 to 1.5 wt. % and particularly preferably from 0.10 to 1.0 wt. %, respectively relative to the sum of components a) to d).

Suitable coloring agents generally have high extinction coefficients in the visible wavelength range and a high thermal stability. A high thermal stability of the coloring agent is thus present if no significant color shift or thermal degradation is observed during the production and processing of the colored molding materials during injection molding or extrusion in the temperature range between 230 and 300° C. In addition, the coloring agents are not to affect or degrade the polymer, which may lead to an unacceptable loss of the mechanical features or to the formation of gaseous byproducts during the molding.

Synthetic coloring agents are typically obtained from coal tar or petroleum intermediates. Dyes of many different types are available for use in thermoplastic materials. The color index lists many different chemical classes of coloring agents, among them, e.g., nitroso, nitro, monoazo, diazo, triazo, polyazo, azo, stilbene, carotenoid, diphenylmethane, triarylmethane, xanthene, quinoline, acridine, methine, thiazole, indamine, indophenol, azine, oxazine, thiazine, sulfur, lactone, aminoketone, hydroxyketone, anthraquinone, indigloid, and phthalocyanine, nigrosin, carbon black and inorganic pigments.

Coloring agents or coloring agent combinations are preferably selected from the group consisting of pyrazolone, perinone and anthraquinone, methine, azo and coumarin coloring agents and/or pigments containing metals, like inorganic pigments and the metal complexes of azo, azomethine, or methine coloring agents, azomethine, quinacridone, dioxazine, isoindoline, isoindolinone, perylene, phthalocyanine, pyrrolo pyrrole, and thioindigo coloring agents, and may be supplemented with carbon black.

Examples of inorganic pigments are antimony trioxide, antimony pentoxide, basic lead carbonate, basic lead sulphate or lead silicate, lithopone, titanium dioxide (anatas, rutil), zinc oxide, zinc sulfide, metal oxides like Prussian blue, lead chromate, lead sulfochromate, chromium antimony titanate, chromium oxide, ferric oxide, cobalt blue, cobalt chromite blue, cobalt nickel grey, manganese blue, manganese violet, molybdate orange, molybdate red, nickel antimony titanate, ultramarine blue, and also metal sulfides like antimony trisulfide, cadmium sulfide, cadmium sulfoselenide, zirconium silicate, zirconium vanadium blue, zirconium praseodymium yellow. Dispersion dyes are suitable, for example, as polymer soluble dyes, like those of the anthraquinone series, for example, alkylamino, amino, arylamino, cyclohexylamino, hydroxy, hydroxyamino, or phenylmercapto anthraquinone, and also metal complexes of azo dyes, in particular 1:2 chromium complex or cobalt complexes of monoazo dyes, and also fluorescent coloring dyes from the benzthiazole, coumarin, oxarin or thiazine series.

It is particularly preferred that the at least one coloring agent is selected from the group consisting of organic dyes, in particular anthraquinone dyes, perinone dyes, nigrosin, carbon black, and mixtures and combinations thereof.

The at least one coloring agent c) preferably contains at least one subsequently listed coloring agent, and the at least one coloring agent c) is particularly preferably selected from the group of the subsequently listed coloring agents, subsequently listed as Color Index Generic Names (CIGN): Solvent Green 3 (CAS no. 128-80-3), Solvent Green 28 (CAS no. 28198-05-2), Solvent Red 52 (CAS no. 81-39-0), Solvent Red 111 (CAS no. 82-38-2), Solvent Red 135 (CAS no. 20749-68-2), Solvent Red 169 (CAS no. 27354-18-3), Solvent Red 179 (CAS no. 89106-94-5), Solvent Red 207 (CAS no. 10114-49-5), Disperse Red 22 (CAS no. 2944-28-7), Vat Red 41 (CAS no. 522-75-8), Solvent Orange 60 (CAS no. 61969-47-9), Solvent Orange 63 (CAS no. 16294-75-0), Solvent Violet 13 (CAS no. 81-48-1), Solvent Violet 14 (CAS no. 8005-40-1), Solvent Violet 50, Disperse Blue 73 (CAS no. 12222-78-5), Solvent Blue 97 (CAS no. CAS 61969-44-6), Solvent Blue 101 (CAS no. 6737-68-4), Solvent Blue 104 (CAS no. 116-75-6), Solvent Blue 138 (CAS no. 110157-96-5), Disperse Yellow 160 (CAS no. 75216-43-2), Solvent Yellow 84 (CAS no. 12239-76-8), Solvent Yellow 93 (CAS no. 4702-90-3), Solvent Yellow 98 (CAS no. 12671-74-8), Solvent Yellow 163 (CAS no. 13676-91-0), Solvent Yellow 160:1 (CAS no. 35773-43-4), and mixtures thereof. These coloring agents have a good thermal stability.

Preferred coloring agents with a phthalocyanine structure are, for example, Pigment Blue 15:1 (CAS no. 147-14-8), Pigment Blue 15:3 (CAS no. 147-14-8), Pigment Blue 16 (CAS no. 574-93-6), and Pigment Green 7 (CAS no. 1328-53-6).

Additionally preferred as component c) Solvent Brown 53 (CAS no. 64696-98-6), Pigment Brown 23 (CAS no. 35869-64-8), Pigment Brown 24 (CAS no. 68186-90-3), Pigment Brown 25 (CAS no. 6992-11-6), Pigment Orange 68 (CAS no. 42844-93-9), Solvent Orange 60 (CAS no. 61969-47-9), Solvent Orange 63 (CAS no. 16294-75-0), and Pigment Brown 6 (CAS no. 52357-70-7).

Particularly preferred dyes are Solvent Red 52, Solvent Red 135, Solvent Red 179, Solvent Violet 13, Solvent Violet 14, Solvent Violet 36, Solvent Violet 50, Disperse Blue 73, Solvent Yellow 93, Solvent Green 3, Disperse Yellow 160, Solvent Blue 97, and mixtures which contain at least one of the previously mentioned dyes.

The coloring agents selected from the group of the following dye mixtures are particularly preferred:
Solvent Green 3 and Solvent Red 179
Solvent Red 52 and Solvent Blue 97
Solvent Green 3, Solvent Blue 97, and Solvent Red 179
Solvent Green 3, Solvent Red 52, and Solvent Red 179
wherein the dye mixtures may additionally contain carbon black. The dye mixtures preferably contain up to 50 wt. % carbon black relative to the dye mixture. The dye mixtures particularly preferably contain 20-50 wt. % carbon black, relative to the dye mixture.

A mixture of the following components is most particularly preferred as the coloring agent:
20-40 wt. % Solvent Green 3
0-20 wt. % Solvent Red 52
15-35 wt. % Solvent Red 179
40-60 wt. % carbon black
wherein the sum of the components yields 100 wt. % of the mixture (component c). The amount of this coloring agent mixture (c) is preferably 0.7 to 0.8 wt. %, relative to the sum of components a) to d).

Types of carbon black are preferably used which have a particle size distribution d₉₀ of <200 nm (this means that at least 90% of the particles are smaller than 200 nm). The particle size distribution may be determined, e.g., by scanning transmission electron microscopy (STEM). These types of carbon blacks are, for example, Color Black FW 1 beads, Corax N115, Black Pearls 1100, Black Pearls 1150, or Black Pearls 880.

The presence of a coloring agent, in particular in the context of the previously mentioned quantities and qualities enables the provision of a polyamide molding material based on transparent polyamides which are characterized by a black piano lacquer finish.

### Additives (d)

The polyamide molding material according to the invention may further contain, e.g., from 0 to 10 wt. % additives (component d)), relative to the sum of components a) to d).

According to one preferred embodiment of the present invention, the proportion of component d) in the polyamide molding material is in the range from 0 to 5.0 wt. % and particularly preferably from 0.10 to 2.0 wt. %, respectively relative to the sum of components a) to d).

Another preferred embodiment provides that the at least one additive d) is selected from the group consisting of monomers, in particular lactams, softeners, impact strength modifiers, condensation catalysts, chain regulators, in particular monofunctional carboxylic acids or amines, defoaming agents, antiblocking agents, natural layered silicates, synthetic layered silicates, nanoscale fillers, and mixtures thereof.

Molded parts may be produced from the polyamide molding material according to the invention, which molded parts are in particular selected from the group consisting of interior and exterior parts for automobiles, motor cycles, camping vehicles or mobile homes, building and facade parts, decorative structural frames, operational buttons or levers, covers, visible surfaces, back-lit components, apertures for mobile telephones, tablets, housings for electronic devices, decorative parts in vehicles, household devices, containers, vehicle keys, leisure and outdoor products.

The subject matter according to the invention will be explained in greater detail on the basis of the following examples, without wishing to be limited to the specific embodiments shown here. The following measuring methods were used in the scope of this application:

Haze, Transparency

Transparency and haze were measured in accordance with ASTM D1003-21 on 2 mm thick plates (60 mm×60 mm surface) using a CIE illuminant C at 23° C. using a Haze Gard Plus measuring device from BYK Gardner.

Relative Viscosity, ηᵣₑₗ

The relative viscosity was determined in accordance with ISO 307 (2007) at 20° C. For this purpose, 0.5 g of polymer granules were weighed into 100 ml m-cresol, and the calculation of the relative viscosity (RV) according to RV=t/t0 was carried out based on Section 11 of the standard.

Tensile Modulus of Elasticity

The determination of the tensile modulus of elasticity and the tensile strength was performed in accordance with ISO 527 (2012) at a tension rate of 1 mm/min at a temperature of 23° C. on an ISO tension rod (type A1, dimensions 170×20/10×4), produced according to the standard: ISO/CD 3167 (2003).

Yield Stress and Elongation at Yield

The determination of the yield stress and elongation at yield was performed in accordance with ISO 527 (2012) at a tension rate of 50 mm/min at a temperature of 23° C. on an ISO tension rod (type A1, dimensions 170×20/10×4 mm), produced according to the standard: ISO/CD 3167 (2003).

Failure Stress and Elongation at Break

The determination of the failure stress and elongation at break was performed in accordance with ISO 527 (2012) at a tension rate of 50 mm/min at a temperature of 23° C. on an ISO tension rod (type A1, dimensions 170×20/10×4 mm), produced according to the standard: ISO/CD 3167 (2003).

Impact Strength According to Charpy

The determination of the impact strength according to Charpy was performed in accordance with ISO 179/2*eU (1997, *2=instrumented) at a temperature of 23° C. on an ISO test rod (type B1, dimensions 80×10×4 mm), produced according to the standard: ISO/CD 3167 (2003).

Notch Impact Strength According to Charpy

The determination of the notch impact strength according to Charpy was performed in accordance with ISO 179/2*eU (1997, *2=instrumented) at a temperature of 23° C. on an ISO test rod (type B1, dimensions 80×10×4 mm), produced according to the standard; ISO/CD 3167 (2003).

Gloss 60%

The gloss was determined in accordance with ISO 2813 (2015) at an angle of 60° and a temperature of 23° C. using a Minolta Multi Gloss 268 device on plates with the dimensions 60×60×2 mm. The gloss level is indicated in non-dimensional gloss units (GU). Test specimens in the dry state were stored for at least 48 h after the injection molding at room temperature in a dry environment, i.e. over silica gel.

Conditioning

The conditioning was conducted in accordance with ISO 527 (2012). The test specimens were thereby stored for 16 hours at 23+−2° C. and 50+−10° relative humidity.

Fracture Energy

The fracture energy is represented by the surface under the curve of the stress-strain curve of the tensile test in accordance with ISO 527 (2012).

Rubbing Resistance

Test device: Crockmeter in accordance with DIN EN ISO 105-X12, or another test device with which the necessary test conditions may be set (test force: 9 N, test path: 104±3 mm)

Test head: rubbing adapter C in accordance with DIN 55654:2015

Test equipment/Rubbing medium: Polishing paper in accordance with DIN 55654:2015: Abrasive grain made of aluminum oxide, semi-open spread, grain 5 μm, grains fully resin bonded to flexibly extruded PES film (e.g., 3M™ 261X1). The cutting of the polishing paper is carried out to an exact width of 25 mm and a minimum length of 75 mm.

Gloss measuring device: The gloss measurement is carried out using a reflectometer at an angle of 20° (in accordance with DIN EN ISO 2813:2015)

Sample preparation: To perform the test, a minimum sample size of 150 mm×100 mm is necessary.

The conditions are established as previously described.

Test Administration:
1. Conditioning
2. Cleaning under flowing, lukewarm water.)
3. Measuring the gloss level prior to scratching. The measurement of the gloss level is carried out at a measurement angle of 20°.
4. Rubbing/Scratching: A new rubbing medium is clamped in prior to each rubbing procedure. A rubbing procedure comprises 5 double strokes. The rubbing is carried out at a load of 9 N. In case the rubbing mark is not uniform (streaked, blemished), a repeat test must be performed.
5. After the rubbing, the samples are stored for 24 h at room temperature. 6. Measuring the gloss at the rubbing mark. The alignment of the gloss measuring device is thereby to be carried out such that the measuring direction is 90° to the rubbing direction. Care should be taken that the measurement opening of the gloss measuring device contacts the loaded surface. The first and last 10 mm of the rubbing mark are not to be measured in this case.

The rubbing resistance is expressed as a relative change in gloss (%) relative to the initial gloss level. The measurement angle is 20°. The relative change in gloss is calculated as follows:

(initial gloss level−gloss level after rubbing)×100/initial gloss level

The materials used in the examples and comparison examples are summarized in Table 1.

TABLE 1

| | |
|---|---|
| Polyamide 1 (Polyamide X) | EMS Chemie AG |
| PA 6I/6T/MACMI/MACMT/ | |
| PACMI/PACMT/12 | |
| (39/39/7.1/7.1/2.2/2.5/2.8) | |
| (Polyamide X), rel. viscosity = 1.62 | |
| Transparency: 93% | |
| Haze: 0.6% | |
| Tg: 159° C. | |
| Polyamide 2 (Polyamide X) | EMS Chemie AG |
| PA 6I/6T/612/MACMI/MACMT/ | |
| MACM12 (20/20/24/11/11/14), | |
| rel. viscosity = 1.74 | |
| Transparency: 93% | |
| Haze: 0.3% | |
| Tg: 149° C. | |
| Polyamide 3 (Polyamide X) | EMS Chemie AG |
| PA MACMI/MACMT/12 (31/30/39) | |
| Transparency: 93% | |
| Haze: 0.6% | |
| Tg: 193° C. | |
| Polyamide 4 (Polyamide Y) | RADIPOL A45, Radici Group |
| PA 66 | |
| Polyamide 5 (Polyamide X) | EMS Chemie AG |
| PA 6 | |
| Polyamide 6 (Comparison example) | EMS Chemie AG |
| PA 6I/6T | |
| Polyamid-7 (Comparison example) | EMS Chemie AG |
| PA 66/6I/6T | |
| Polyamide 8 (Comparison example) | EMS Chemie AG |
| PA 12 | |
| Irganox 1098 | N,N′-(hexane-1,6-diyl)bis[3-(3,5- |
| (Component b) | di-tert-butyl-4-hydroxyphenyl) |
| | propanamide] |
| | (BASF SE) (Additive b)) |
| HOSTANOX PAR24 | Tris(2,4-di-tert-butylphenyl) |
| (Component b) | phosphite (Clariant AG) |
| | (Additive b)) |
| TINUVIN 312/SANDUVOR VSU | N-(2-Ethoxyphenyl)-N′-(2- |
| (Component b) | ethylphenyl)oxamide (BASF SE |
| | or Clariant AG) |
| TINUVIN 770DF/LOWILITE 77 | Bis(2.2,6,6-tetramethyl-4- |
| (Component b) | piperidyl)sebacate (BASF AG |
| | or Addivant) |
| Calcium stearate | FACI S.p.A., IT |
| (Component b) | |
| Coloring agent 1 (component c) | Macrolex dyes from Lanxess, DE |
| Mixture of: 47.0 wt. % RUSS | Carbon black from Cabot, NL |
| BLACK PEARLS 1100, 28.5 wt. % | |
| Macrolex Green 5B (Solvent Green | |
| 3; 61′565), 23.15 wt. % Macrolex | |
| Red E2G (Solvent Red 179; | |
| 564′150), and 1.35 wt. % Macrolex | |
| Red 5B (Solvent Red 52; 68′210) | |
| Coloring agent 2 (component c) | Macrolex dyes from Lanxess, DE |
| Mixture of: 47.0 wt. % Color Black | Carbon black from Orion |
| FW 1 beads, 28.5 wt. % Macrolex | Engineered Carbons, DE |
| Green 5B (Solvent Green 3; 61′565), | |
| 23.15 wt. % Macrolex Red E2G | |
| (Solvent Red 179; 564′150), and 1.35 | |
| wt. % Macrolex Red 5B (Solvent | |
| Red 52; 68′210) | |
| Coloring agent 3 (component c) | Macrolex dyes from Lanxess, DE |
| Mixture of: 28.6 wt. % Macrolex | |
| Green 5B (Solvent Green 3; 61′565), | |
| 50.0 wt % Macrolex Red E2G | |
| (Solvent Red 179; 564′150), and 21.4 | |
| wt % Macrolex Blue RR (Solvent | |
| Blue 97; 651′290) | |
| Coloring agent 4 (component c) | Polysynthren Black from Heubach |
| Mixture of: 47.0 wt. % Color Black | GmbH, DE |
| FW 1 beads, 53.0 wt. % | Carbon black from Orion |
| Polysynthren Black H (Solvent black | Engineered Carbons, DE |
| 27, CAS no. 72812-34-1) | |

Polyamide molding materials according to the invention (examples) are listed in the following Tables 2 and 4, and compounds not according to the invention (comparison examples) are listed in Tables 3 and 5 and the respectively determined measured values are indicated. The information about amounts is presented in parts per weight.

TABLE 2

| | Example 1 | Example 2 | Example 3 | Example 4 | Example 5 | Example 6 |
|---|---|---|---|---|---|---|
| Polyamide-2 | 48.929 | 48.929 | 24.466 | 24.466 | | |
| Polyamide-1 | | | | | 24.466 | 24.466 |
| Polyamide-3 | | | | | | |
| Polyamide 4 | 48.926 | | 73.389 | | | 73.389 |
| Polyamide 5 | | 48.926 | | 73.389 | 73.389 | |
| Polyamide 6 | | | | | | |
| Polyamide 8 | | | | | | |
| Polyamide 7 | | | | | | |
| Coloring agent 1 | 0.745 | 0.745 | 0,745 | 0.745 | 0.745 | 0.745 |
| Coloring agent 2 | | | | | | |
| Coloring agent 3 | | | | | | |
| Coloring agent 4 | | | | | | |
| CA-STEARATE | 0.5 | 0.5 | 0.5 | 0.5 | 0.5 | 0.5 |
| IRGANOX 1098 | 0.2 | 0.2 | 0.2 | 0.2 | 0.2 | 0.2 |
| HOSTANOX PAR24 | 0.2 | 0.2 | 0.2 | 0.2 | 0.2 | 0.2 |
| TINUVIN 312/SANDUVOR VSU | 0.2 | 0.2 | 0.2 | 0.2 | 0.2 | 0.2 |
| TINUVIN 770DF/LOWILITE 77 | 0.3 | 0.3 | 0.3 | 0.3 | 0.3 | 0.3 |

| | Example 7 | Example 8 | Example 9 | Example 10 | Example 11 |
|---|---|---|---|---|---|
| Polyamide-2 | | | | | |
| Polyamide-1 | 24.466 | | 24.466 | 24.552 | 24.466 |
| Polyamide-3 | | 24.775 | | | |
| Polyamide 4 | 58.712 | 74.325 | 73.389 | 73.648 | 73.389 |
| Polyamide 5 | 14.678 | | | | |
| Polyamide 6 | | | | | |
| Polyamide 8 | | | | | |
| Polyamide 7 | | | | | |
| Coloring agent 1 | 0.745 | 0.745 | | | |
| Coloring agent 2 | | | 0.745 | | |
| Coloring agent 3 | | | | 0.400 | |
| Coloring agent 4 | | | | | 0.745 |
| CA-STEARATE | 0.5 | 0.5 | 0.5 | 0.5 | 0.5 |
| IRGANOX 1098 | 0.2 | 0.2 | 0.2 | 0.2 | 0.2 |
| HOSTANOX PAR24 | 0.2 | 0.2 | 0.2 | 0.2 | 0.2 |
| TINUVIN 312/SANDUVOR VSU | 0.2 | 0.2 | 0.2 | 0.2 | 0.2 |
| TINUVIN 770DF/LOWILITE 77 | 0.3 | 0.3 | 0.3 | 0.3 | 0.3 |

TABLE 3

| | Com- | Com- | Com- | Com- | Com- | Com- | Com- | Com- | Com- |
|---|---|---|---|---|---|---|---|---|---|
| | parison | parison | parison | parison | parison | parison | parison | parison | parison |
| | example 1 | example 2 | example 3 | example 4 | example 5 | example 6 | example 7 | example 8 | example 9 |
| Polyamide-2 | | | | | | | | | |
| Polyamide-1 | 73.392 | 48.929 | 24.463 | 73.392 | 73.392 | 73.392 | | 24.466 | 97.855 |
| Polyamide-3 | | | | | | | | | |
| Polyamide 4 | | | | 24.463 | | 19.570 | 73.389 | | |
| Polyamide 5 | | | | | 24.463 | 4.893 | | | |
| Polyamide 6 | | | | | | | 24.466 | | |
| Polyamide 8 | 24.463 | 48.926 | 73.392 | | | | | | |
| Polyamide 7 | | | | | | | | 73.389 | |
| Coloring | 0.745 | 0.745 | 0.745 | 0.745 | 0.745 | 0.745 | 0.745 | 0.745 | 0.745 |
| agent 1 | | | | | | | | | |
| Ca-Stearate | 0.5 | 0.5 | 0.5 | 0.5 | 0.5 | 0.5 | 0.5 | 0.5 | 0.5 |
| IRGANOX | 0.2 | 0.2 | 0.2 | 0.2 | 0.2 | 0.2 | 0.2 | 0.2 | 0.2 |
| 1098 | | | | | | | | | |
| HOSTANOX | 0.2 | 0.2 | 0.2 | 0.2 | 0.2 | 0.2 | 0.2 | 0.2 | 0.2 |
| PAR24 | | | | | | | | | |
| TINUVIN 312/ | 0.2 | 0.2 | 0.2 | 0.2 | 0.2 | 0.2 | 0.2 | 0.2 | 0.2 |
| SANDUVOR | | | | | | | | | |
| VSU | | | | | | | | | |
| TINUVIN | 0.3 | 0.3 | 0.3 | 0.3 | 0.3 | 0.3 | 0.3 | 0.3 | 0.3 |
| 770DF/ | | | | | | | | | |
| LOWILITE 77 | | | | | | | | | |

The measured values obtained with the compounds according to the invention of examples 1 to 11 and the comparison examples 1 to 9 are listed in the following Tables 4 and 5.

TABLE 4

| Measurement | Measurement | | | | | | | |
|---|---|---|---|---|---|---|---|---|
| variable [unit] | condition | Conditioning | Example 1 | Example 2 | Example 3 | Example 4 | Example 5 | |
| Tensile modulus of | 23° C., 50 mm/min | conditioned | 2108 | 1736 | 1718 | 1119 | 1656 | |
| elasticity | | | | | | | | |
| [MPa] | | | | | | | | |
| Yield stress [MPa] | 23° C., 50 mm/min | conditioned | 68.9 | 60.5 | 59.6 | 46.8 | 79.6 | |
| Elongation at yield | 23° C., 50 mm/min | conditioned | 6.5 | 6.6 | 12.4 | 16.0 | 8.8 | |
| [%] | | | | | | | | |
| Breaking stress | 23° C., 50 mm/min | conditioned | 51.9 | 67.7 | 51.2 | 66.1 | 63.3 | |
| [MPa] | | | | | | | | |
| Elongation at | 23° C., 50 mm/min | conditioned | 172.4 | 212 | 188.2 | 256 | 311.5 | |
| break [%] | | | | | | | | |
| Fracture energy [J] | 23° C., 50 mm/min | conditioned | 255.6 | 302.7 | 271.2 | 355.2 | 387.4 | |
| Impact strength | 23° C. | conditioned | WC | WC | WC | WC | WC | |
| [kJ/m²] | | | | | | | | |
| Notch impact | 23° C. | conditioned | 9.2 | 13.9 | 9.3 | 26.0 | 17.6 | |
| strength [kJ/m²] | | | | | | | | |
| Visual assessment | with the naked | dry | Grey | Grey | Grey | Grey | Piano Black | |
| of color plates | eye | | filming | filming | filming | filming | | |
| Gloss 20% | Original gloss | dry | 93 | 88 | 90 | 68 | 88 | |
| | level (AG; | | | | | | | |
| | untreated plate) | | | | | | | |
| Gloss 20% | Gloss level after | dry | 12 | 13 | 12 | 14 | 78 | |
| | rubbing (GnR; | | | | | | | |
| | scratch surface) | | | | | | | |
| Percentage decrease in gloss 20% | | dry | 87 | 85 | 87 | 79 | 11 | |
| Measurement | Measurement | | | | | | Example | Example |
| variable [unit] | condition | Conditioning | Example 6 | Example 7 | Example 8 | Example 9 | 10 | 11 |
| Tensile modulus of | 23° C., 50 mm/min | conditioned | 2520 | 1955 | 1603 | 2585 | 2507 | 2404 |
| elasticity | | | | | | | | |
| [MPa] | | | | | | | | |
| Yield stress [MPa] | 23° C., 50 mm/min | conditioned | 64 | 53.2 | 57.1 | 66 | 64 | 62 |
| Elongation at yield | 23° C., 50 mm/min | conditioned | 4.5 | 6.2 | 14.1 | 4.5 | 4.7 | 4.8 |
| [%] | | | | | | | | |
| Breaking stress | 23° C., 50 mm/min | conditioned | 51.4 | 56.9 | 52.5 | 53.4 | 56.9 | 54.2 |
| [MPa] | | | | | | | | |
| variable [unit] | condition | | | | | | | |
| Elongation at | 23° C., 50 mm/min | conditioned | 268.8 | 281.4 | 158.5 | 264.5 | 270.1 | 254.6 |
| break [%] | | | | | | | | |
| Fracture energy [J] | 23º° C., 50 mm/min | conditioned | 386.5 | 382.5 | 242.8 | 389.1 | 382.4 | 376.5 |
| Impact strength | 23° C. | conditioned | WC | WC | WC | WC | WC | WC |
| [kJ/m²] | | | | | | | | |
| Notch impact | 23° C. | conditioned | 9.2 | 10.7 | 13.7 | 9.4 | 9.3 | 9.1 |
| strength [kJ/m²] | | | | | | | | |
| Visual assessment | with the naked | dry | Piano | Piano | Piano | Piano | Piano | Piano |
| of color plates | eye | | Black | Black | Black | Black | Black | Black |
| Gloss 20% | Original gloss | dry | 92 | 92 | 95 | 93 | 92 | 94 |
| | level (AG; | | | | | | | |
| | untreated plate) | | | | | | | |
| Gloss 20% | Gloss level after | dry | 70 | 77 | 22 | 71 | 73 | 70 |
| | rubbing (GnR; | | | | | | | |
| | scratch surface) | | | | | | | |

| | | | | | | | |
|---|---|---|---|---|---|---|---|
| Percentage decrease in gloss 20% | dry | 24 | 16 | 77 | 24 | 21 | 26 |

WC: without cracking

TABLE 5

| Measurement | Measurement | | Comparison | Comparison | Comparison | Comparison | Comparison |
|---|---|---|---|---|---|---|---|
| variable [unit] | condition | Conditioning | example 1 | example 2 | example 3 | example 4 | example 5 |
| Tensile modulus | 23° C., 50 mm/min | conditioned | 2383 | 1782 | 1367 | 2977 | 2992 |
| of elasticity [MPa] | | | | | | | |
| Yield stress [MPa] | 23° C., 50 mm/min | conditioned | 77.8 | 53.8 | 45.9 | 87.3 | 87.7 |
| Elongation at | 23° C., 50 mm/min | conditioned | 5.7 | 7.3 | 9.5 | 5 | 4.7 |
| yield [%] | | | | | | | |
| Breaking stress | 23° C., 50 mm/min | conditioned | 47.5 | 52.4 | 36.2 | 45.3 | 42.1 |
| [MPa] | | | | | | | |
| Elongation at | 23° C., 50 mm/min | conditioned | 35.8 | 9.5 | 54 | 29 | 13.3 |
| break [%] | | | | | | | |
| Fracture energy | 23º° C., 50 mm/min | conditioned | 58.9 | 12.5 | 61.8 | 47.8 | 22.3 |
| [J] | | | | | | | |
| Impact strength | 23° C. | conditioned | 40% WC/ | 109.7 | WC | 80% WC/ | 60% WC/ |
| [kJ/m²] | | | 60% 244 | | | 20% 92 | 40% 282 |
| Notch impact | 23° C. | conditioned | 9.6 | 4.2 | 4.4 | 8.8 | 8.6 |
| strength [kJ/m²] | | | | | | | |
| Visual assessment | with the naked | dry | Streaks/ | Grey filming/ | Grey filming/ | Piano Black | Piano Black |
| of color plates | eye | | Grey filming | Blemishes | Blemishes | | |
| Gloss 20% | Original gloss | dry | 96 | 86 | 50 | 100 | 100 |
| | level (AG; | | | | | | |
| | untreated plate) | | | | | | |
| Gloss 20% | Gloss level after | dry | 28 | 18 | 6 | 18 | 13 |
| | rubbing (GnR; | | | | | | |
| | scratch surface) | | | | | | |

| | | | | | | |
|---|---|---|---|---|---|---|
| Percentage decrease in gloss 20% | dry | 71 | 79 | 88 | 82 | 87 |

| Measurement | Measurement | | Comparison | Comparison | Comparison | Comparison |
|---|---|---|---|---|---|---|
| variable [unit] | condition | Conditioning | example 6 | example 7 | example 8 | example 9 |
| Tensile modulus | 23° C., 50 mm/min | conditioned | 2998 | 2960 | 2915 | 2889.0 |
| of elasticity [MPa] | | | | | | |
| Yield stress [MPa] | 23° C., 50 mm/min | conditioned | 89.8 | 71.9 | 75.1 | 95.8 |
| Elongation at | 23° C., 50 mm/min | conditioned | 5.2 | 4 | 4.1 | 5.8 |
| yield [%] | | | | | | |
| Breaking stress | 23° C., 50 mm/min | conditioned | 47.5 | 43.2 | 41.8 | 56.5 |
| [MPa] | | | | | | |
| Elongation at | 23° C., 50 mm/min | conditioned | 42.2 | 110.2 | 24.5 | 73.4 |
| break [%] | | | | | | |
| Fracture energy | 23° C., 50 mm/min | conditioned | 68.6 | 167.7 | 40.8 | 133.8 |
| [J] | | | | | | |
| Impact strength | 23° C. | conditioned | WC | WC | WC | WC |
| [kJ/m²] | | | | | | |
| Notch impact | 23° C. | conditioned | 8.3 | 6.3 | 9.7 | 9.9 |
| strength [kJ/m²] | | | | | | |
| Visual assessment | with the naked | dry | Piano Black | Piano Black | Grey haze | Piano Black |
| of color plates | eye | | | | | |
| Gloss 20% | Original gloss | dry | 101 | 91 | 53 | 105 |
| | level (AG; | | | | | |
| | untreated plate) | | | | | |
| Gloss 20% | Gloss level after | dry | 20 | 1 | 8 | 19 |
| | rubbing (GnR; | | | | | |
| | scratch surface) | | | | | |

| | | | | | |
|---|---|---|---|---|---|
| Percentage decrease in gloss 20% | dry | 80 | 99 | 85 | 82 |

WC: without cracking

As is clear from the examples, its specific combination of polyamides X and Y is required to achieve a high value for the fracture energy. At the same time, a desired visual effect (piano black) may not only be achieved, but the rubbing resistance may also be thereby completely surprisingly increased.

1-19. (canceled)

20. A polyamide molding material comprising the following components:
a) 93.0 to 99.9 wt. % of a mixture M consisting of 15.0 to 50.0 wt. % of at least one polyamide X and 50.0 to 85.0 wt. % of at least one polyamide Y selected from the group consisting of PA6, PA66, PA6/66, PA610, PA612, PA 614, PA 616, PA 6/12, and mixtures thereof;
b) 0.05 to 5.0 wt. % of at least one additive;
c) 0.01 to 2.0 wt. % of at least one coloring agent; and optionally
d) ingredients other than components a) to c);
wherein the at least one polyamide X is selected from the group consisting of polyamides, which comprise at least the amidically-bonded polyamide units AC, BC and E, or AC, BC, AD and BD, or AC and E, derived from the monomer units A, B, C, D, and/or E, wherein the monomer units A, B, C, D, and E have the following definition:
A: at least one cycloaliphatic diamine;
B: at least one acyclic aliphatic diamine;
C at least one aromatic dicarboxylic acid;
D: at least one aliphatic dicarboxylic acid;
E: at least one α,ω-amino carboxylic acid or at least one lactam;
wherein the sum of the components X and Y yields 100 wt. % of the mixture M and the sum of the components a), b), c), and d) yields 100 wt. %.

21 The polyamide molding material according to claim 20, wherein the at least one additive (b) is included at 0.10 to 3.0 wt. % and/or
the at least one coloring agent (c) is included at 0.05 to 2.0 wt. % and/or
0 to 5.0 wt. % ingredients (d) are included.

22. The polyamide according to claim 20, wherein monomer units A to E are respectively selected independently from one another from the group consisting of
A: cycloaliphatic diamines selected from the group consisting of bis-(4-amino-3-methyl-cyclohexyl)-methane (MACM), bis(4-amino-cyclohexyl)methane (PACM), bis-(4-amino-3,5-dimethyl-cyclohexyl)-methane (TMDC) and mixtures thereof;
B: acyclic aliphatic diamines selected from the group con-sisting of 1,6-hexanediamine, 2-methyl-1,8-octanediamine, 1,9-nonanediamine, 1,10-decanediamine, 1,12-dodecane-diamine, preferably selected from 1,6-hexanediamine and 1,10-decanediamine;
C: aromatic dicarboxylic acids selected from the group consisting of terephthalic acid, isophthalic acid and mixtures thereof, preferably a mixture of terephthalic acid and isophthalic acid;
D: aliphatic dicarboxylic acids selected from the group consisting of adipic acid, azelaic acid, 1,10-decanedioic acid, 1,12-dodecanedioic acid, 1,14-tetradecanedioic acid, 1,16-hexadecanediodc acid, cyclohexane-1,3-dicarboxylic acid, cyclohexane-1,4-dicarboxylic acid and mixtures thereof; and
E: α,ω-aminocarboxylic acids or the lactams selected from the group consisting of α,ω-aminohexanoic acid, α,ω-aminoundecanoic acid, α,ω-aminododecanoic acid, caprolactam, laurolactam, and mixtures thereof.

23. The polyamide according to claim 20, wherein the polyamide unit AC comprises at least two different cycloaliphatic diamines.

24. The polyamide molding material according to claim 20, wherein the mixture M consists of 15.0 to 45.0 wt. % of at least one polyamide X and 55.0 to 85.0 wt. % of at least one polyamide Y.

25. The polyamide molding material according to claim 20, wherein the polyamide X contains more than 30 mol % of monomers with aromatic structural units, relative to the total amount of monomers.

26. The polyamide molding material according to claim 20, wherein the polyamide X is selected from the group consisting of PA 6I/6T/MACMI/MACMT/PACMI/PACMT/12, PA 6I/6T/MACMI/MACMT/MACM12/612, PA MACMI/12, PA MACMT/12, PA 10I/MACMI/MACM10/1010, PA 10T/MACMT/MACM10/1010, PA 10I/10T/MACMI/MAMT/MACM10/1010 PA MACMI/MACMT, PA MACMI/MACMT/12, PA MACMI/MACMT/MACM12, PA 6I/6T/MACMI/MACMT, PA 6I/6T/MACMI/MACMT/12, PA 6I/612/MACMI/MACM12, PA 6T/612/MACMT/MACM12, PA 6I/6T/612/MACMI/MACMT/MACM12, PA 6I/6T/MACMI/MACMT/PACMI/PACMT/MACM12/PACM12, and mixtures thereof.

27. The polyamide molding material according to claim 20, wherein the polyamide molding material is free of PA MACMI/12.

28. The polyamide molding material according to claim 20, wherein the polyamide X has a transparency of at least 88% and a haze of at most 5% respectively determined in accordance with ASTM-D1003-21 on a plate with dimensions 60×60×2 mm.

29. The polyamide molding material according claim 21, wherein the coloring agent (c) is selected from the group consisting of organic dyes.

30. The polyamide molding material according to claim 21, wherein the coloring agent contains a combination of carbon black and at least one dye or pigment selected from the group consisting of pyrazolone dyes, perinone dyes, anthraquinone dyes, methane dyes, azo dyes, coumarin dyes, and pigments containing metals.

31. The polyamide molding material according to claim 30, wherein the proportion of carbon black in the combination is 20-50 wt. %, relative to the dye combination.

32. The polyamide molding material according to claim 20, wherein the coloring agent (c) consists of
carbon black, Solvent Green 3, Solvent Red 52, and Solvent Red 179, or
carbon black and Polysynthren Black H (Solvent Black 27, CAS no. 72812-34-1), wherein the proportion of carbon black is 20-50 wt. %, relative to the coloring agent.

33. The polyamide molding material according to claim 20, wherein the coloring agent contains a combination of at least two dyes selected from the group consisting of pyrazolone dyes, perinone dyes, anthraquinone dyes, methane dyes, azo dyes, and coumarin dyes and/or pigments containing metals; and wherein the polyamide molding material is free of carbon black.

34. The polyamide molding material according to claim 20, wherein the coloring agent consists of a combination of Solvent Green 3, Solvent Red 179, and Solvent Blue 97.

35. The polyamide molding material according claim 20, wherein the at least one additive (b) is selected from the group consisting of organic and inorganic stabilizers.

36. The polyamide molding material according to claim 20, wherein the at least one ingredient d) differing from additives b) and coloring agent c) is included, and wherein said ingredient different d) is selected from the group consisting of softeners, impact strength modifiers, condensation catalysts, chain regulators, defoaming agents, antiblocking agents, natural layered silicates, synthetic layered silicates, nanoscale fillers, and mixtures thereof.

37. The polyamide molding material according to claim 20, wherein the polyamide molding material is free of impact strength modifiers.

38. A molded part containing a polyamide molding material according to claim 20.

39. The molded part according to claim 38, which is selected from the group consisting of interior and exterior parts for automobiles, motor cycles, camping vehicles or mobile homes, building and facade parts, decorative structural frames, operational buttons or levers, covers, visible surfaces, back-lit components, apertures for mobile telephones, tablets, housing for electronic devices, decorative parts in vehicles, household devices, containers, vehicle keys, leisure and outdoor products.
